(19) United States
(12) Patent Application Publication
(10) Pub. No.: US 2007/0047965 A1
(43) Pub. Date: Mar. 1, 2007

(54) Dynamic amplitude and spectral shaper in fiber laser amplification system

(75) Inventors: Jian Liu, Sunnyvale, CA (US); Jiangfan Xia, Santa Clara, CA (US)

Correspondence Address: Bo-In Lin, 13445 Mandoli Drive, Los Altos Hills, CA, 94022, US

(73) Assignee: PolarOnyx, Inc.

(21) Appl. No.: 11/512,897

(22) Filed: Aug. 29, 2006

Related U.S. Application Data
(60) Provisional application No. 60/713,650, filed on Aug. 29, 2005.
(60) Provisional application No. 60/713,653, filed on Aug. 29, 2005.
(60) Provisional application No. 60/713,654, filed on Aug. 29, 2005.
(60) Provisional application No. 60/714,468, filed on Sep. 1, 2005.
(60) Provisional application No. 60/714,570, filed on Sep. 7, 2005.

(51) Int. Cl. H04B 10/12

(52) U.S. Cl. 398/147

(57) ABSTRACT

A method for overcoming the drawback in a fiber CPA laser system that includes a process of generating a large negative TOD by implementing an AODS in a pulse shaper as a dispersive component. The AODS is implemented to arbitrarily modulate both the spectrum shape and phase to control with controllable amplitude to generate different orders of dispersions including a large negative TOD for compensating the positive TOD generated by the pulse stretching and amplification processes. The AODS, implemented as a dispersive component, can be an active and controllable dispersive component to generate adjustable levels of dispersions for flexibly compensating any order of dispersions generated in the amplifier chain including the nonlinear phase shift. The AODS implemented as a dispersive component can be an active and programmable dispersive component to interactively generate adjustable levels of dispersions in response to output laser amplitude and pulse shape measurements for flexibly compensating any order of dispersions generated in the amplifier chain including the nonlinear phase shift to achieve the shortest pulse duration.

This Formal Application claims a Priority Date of Aug. 29, 2005 benefited from a Provisional Patent Applications 60/713,650, 60/713,653, and 60/713,654 and a Priority Date of Sep. 1, 2005 benefited from Provisional Application 60/714,468 and 60/714,570 filed by one of the same Applicants of this application.

### FIELD OF THE INVENTION

The present invention relates generally to apparatuses and methods for providing fiber laser system. More particularly, this invention relates a design for dispersion compensation in Chirped Pulse Amplification (CPA) fiber laser system by dynamically shaping the amplitude and spectrum.

### BACKGROUND OF THE INVENTION

Even though current technologies of fiber laser have made significant progress toward achieving a compact and reliable fiber laser system providing high quality output laser with ever increasing output energy, however those of ordinary skill in the art are still confronted with technical limitations and difficulties. Specifically, in a fiber laser system implemented with the Chirped Pulse Amplification (CPA) for short pulse high power laser amplifier, the CPA systems are still limited by the technical difficulties that the third order dispersion (TOD) limits the scalability of the laser systems. Such limitations were not addressed in the conventional technologies due to the fact that the conventional solid-state laser utilizes Grating-Lens combination and Treacy compressor for pulse stretching and compressing. Ideally, in such solid-state systems, all orders of dispersion can be compensated, but the material dispersion can distort and damage this ideal situation. But the material dispersion is not a serious problem in solid-state laser system because the material dispersion is generally considered as not important. However, for a fiber laser system, the situation is different due to the fact that in the fiber laser systems, attempts are made by using the fiber stretcher to replace the grating-lens combination for the purpose of significantly increasing the system reliability. However, the TOD limits the ability for de-chirping when using Treacy compressor since both fiber stretcher and Treacy compressor have positive TOD even this combination can remove the second order dispersion completely. This issue of TOD dispersion makes it more difficult to develop a high-energy fiber laser amplifier with <200 fs pulse width. Actually, the technical difficulty of TOD dispersion is even more pronounced for laser system of higher energy. A laser system of higher energy requires a higher stretch ratio and that leads to a higher TOD. Therefore, for laser system of higher energy, it is even more difficult to re-compress the pulse to the original pulse width. This difficulty is generally referred to as compressibility issue.

Therefore, a need still exists in the art of fiber laser design and manufacture to provide a new and improved configuration and method to provide fiber laser by taking advantage of the amplitude and spectral modulation to compensate the dispersion and to shape the laser pulses such that the above-discussed difficulty may be resolved.

### SUMMARY OF THE PRESENT INVENTION

It is therefore an aspect of the present invention to provide a new pulse shaper that implements an acoustic-optic dispersive shaper (AODS) to modulate the amplitude and spectral as a dispersive filter to generate a large negative TOD for compensating the higher order dispersion including the dispersion caused by the TOD such that the above-discussed difficulties as that encountered in the prior art may be resolved.

It is another aspect of this invention that in order to further compensate a higher dispersion, a pulse shaper is implemented in a fiber laser system that includes an acoustic optic dispersive shaper (AODS) as a dispersive component to arbitrarily modulate both the spectrum shape and phase to control with controllable amplitude to generate different orders of dispersions including a large negative TOD for compensating the positive TOD generated by the pulse stretching and amplification processes such that a high quality, compact and reliable fiber laser system can be provided.

It is a further aspect of this invention that the acoustic optic dispersive shaper (AODS) as a dispersive component can be an active and controllable dispersive component to generate adjustable levels of dispersions for flexibly compensating any order of dispersions generated in the amplifier chain including the nonlinear phase shift.

It is a further aspect of this invention that the acoustic optic dispersive shaper (AODS) as a dispersive component can be an active and programmable dispersive component to interactively generate adjustable levels of dispersions in response to output laser amplitude and pulse shape measurements for flexibly compensating any order of dispersions generated in the amplifier chain including the nonlinear phase shift to achieve the shortest pulse duration.

Briefly, in a preferred embodiment, the present invention discloses a fiber Chirped Pulse Amplification (CPA) laser system that includes a fiber mode-locking oscillator, a fiber stretcher, a pulse shaper, a multistage amplifier chain and a compressor wherein the pulse shaper implements an acoustic optic modulate to flexibly modulate an amplitude and pulse shape to generate different orders of dispersions including a negative third order dispersion for compensation a positive TOD generated the stretcher and the chain of amplifiers.

In a preferred embodiment, this invention further discloses a method for overcoming the drawback in a fiber CPA laser system. The method includes a process of generating a large negative TOD by implementing an AODS in a pulse shaper as a dispersive component. The AODS is implemented to arbitrarily modulate both the spectrum shape and phase to control with controllable amplitude to generate different orders of dispersions including a large negative TOD for compensating the positive TOD generated by the pulse stretching and amplification processes. The AODS, implemented as a dispersive component, can be an active and controllable dispersive component to generate adjustable levels of dispersions for flexibly compensating any order of dispersions generated in the amplifier chain including the nonlinear phase shift. The AODS implemented as a dispersive component can be an active and programmable dispersive component to interactively generate adjustable levels of dispersions in response to output laser amplitude and pulse shape measurements for flexibly compensating any order of dispersions generated in the amplifier chain including the nonlinear phase shift to achieve the shortest pulse duration.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram for showing a fiber laser system implemented with a pulse shaper of this invention.

FIG. 2 is a pulse shape diagram showing a modulated spectrum of AO dispersive filter.

FIG. 3 shows the schematic drawing of the AODS.

FIG. 4 is a schematic diagram for showing one implementation of the AODS in a fiber CPA laser system FIG. 5 is a schematic diagram of a fiber pigtailed AODS used in the all fiber CPA laser system.

FIG. 6 is a schematic diagram of a second AODS can help to achieve shorter pulse duration.

### DETAILED DESCRIPTION OF THE INVENTION

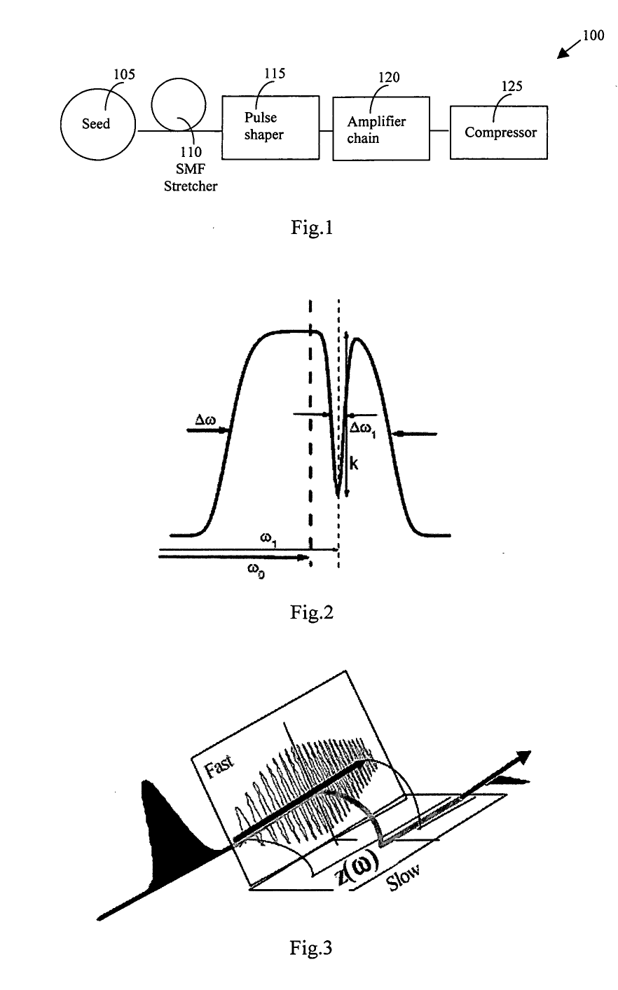

Referring to FIG. 1 for a schematic diagram of a fiber laser system 100 of this invention that implements a dispersion compensator of this invention. The laser system 100 includes a laser seed 105 for generating a seed laser for projecting into a laser stretcher 110 comprises single mode fiber (SMF) to stretch the laser pulse. The stretcher 110 generates laser pulse with stretched pulse width is projected into a pulse shaper 115. The pulse shaper 115 applies an amplitude-and-spectral modulation as will be described below to shape the laser pulses for projecting into a series of laser amplifiers 120 to amplify the laser into higher energy. The amplified laser is then projected into a compressor 125 to recompress the pulse width of the laser to output a laser with the original pulse width.

The pulse shaper 115 implements an acoustic-optic dispersive shaper (AODS) as a dispersive component. In its working range, the AODS can arbitrarily modulate both the spectrum shape and phase. Mathematically one can multiply the modulation factor S(ω) with the input spectrum to get the output spectrum, as shown in FIG. 2.

The modulation factor can be written as

$$S ( ω ) = A ( ω ) {ⅇ}^{ⅈϕ ( ω )} \\ A ( ω ) = {ⅇ}^{- {( \frac{ω - {ω}_{0}}{Δ ω} )}^{6}} \times [ 1 - k \cdot {ⅇ}^{- {( \frac{ω - {ω}_{1}}{ Δ {ω}_{1}} )}^{2}} ] \\ ϕ ( ω ) = - [ {a}_{1} ( ω - {ω}_{0} ) + \frac{{a}_{2}}{2} {( ω - {ω}_{0} )}^{2} + \frac{{a}_{3}}{6} {( ω - {ω}_{0} )}^{3} + \frac{{a}_{4}}{24} {( ω - {ω}_{0} )}^{4} ] \qquad ( 1 )$$

The modulation spectrum as defined by above equations provides the features of two kinds of filtering. First, the amplitude can be controlled by the convolution of a super Gaussian envelope superposed by a Gaussian hole, i.e., the deep and sharp intensity drop as shown in FIG. 2, which can be used to overcome the gain narrowing effect often happens in high gain amplification. Second, the phase is controlled up to 4th order, which means the filter can generate arbitrary second, third, and fourth orders of dispersion. Practically, the second order dispersion of AODS type filter cannot be very big; however, the TOD can have a very large negative value (on the order of −10⁶fs³), which is extremely useful in the high-energy fiber CPA system.

In general, there are many methods can be applied to control the amplitude and phase of the femtosecond laser pulses, such as the liquid crystal modulators, the deformable mirrors or the acousto-optic deflectors. The specific embodiments as disclosed by this patent application is not intended to limit the scope of such implementation but only to enable those of ordinary skill in the art to practice the invention. Among these methods, a laser system implemented with the AODS has the advantage that a more compact configuration and more stable laser projection are achievable. However, it is understood that in addition to the AODS several of these amplitude and phase modulations are feasible and may be employed to achieve the functions of generating large negative TOD to compensate and resolve the TOD difficulties.

FIG. 3 is a schematic diagram for showing the operational principles of the AODS. The AODS is based on a collinear acoustic-optic interaction. An acoustic wave is launched in an acousto-optic birefringent material, such as the tellurium dioxide crystal, gallium phosphide, indium phosphide, lithium niobate, and fused quartz, by a transducer excited by a temporal RF signal. The acoustic wave propagates with a velocity along the z-axis of the crystal and hence reproduces spatially the temporal shape of the RF signal by generating a refractive index wave.

Unlike the common used AO modulator, in the AODS, the acoustic wave moves along with the optical wave. This acoustic wave has a time dependent frequency, which provides the control over the group delay of the diffracted optical pulse. The principle is as follows. It is well known that two optical modes can be coupled efficiently by acousto-optic interaction only in the case of phase matching; generally referred to as fast mode and slow mode. If there is locally only one spatial frequency in the acoustic grating, then only one optical frequency can be diffracted at a position z. The incident optical short pulse is initially in fast mode of the birefringent crystal. Since short pulse will have broad bandwidth, every optical frequency component travels a certain distance before it encounters a phase matched spatial frequency in the acoustic grating. At this position, part of the energy is diffracted in slow mode. The pulse leaving the device at slow mode will be made up of all the spectral components that have been diffracted at various positions. Since the velocities of the two modes are different, each optical frequency will see a different time delay. This delay constitutes the group velocity dispersion (GVD). The derivative of the GVD is generally known as the third order dispersion, i.e., TOD. The TOD can be controlled through the tuning of the time dependent frequency of the acoustic wave. In this way, the fourth order dispersion and other higher order dispersion can also be created and modified.

Simultaneously, the spectral amplitude of the diffracted optical pulse can be controlled through the adjustment of the acoustic wave intensity. By applying the Acoustic-optical modulator as described modulation shown in Equation (1) is achieved. It should also be pointed out that the collinear interaction geometry maximizes the interaction length, thus much deeper modulation and much larger high order dispersion can be generated.

Referring to FIG. 1 again that shows a schematic setup of the application of the AODS type pulse shaper 115 in fiber CPA system. Comparing with other disclosures includes the patent application Ser. Nos. 11/093,519 and 11/136,040 the disclosures of these Patent Applications are hereby incorporated by reference in this Patent Application, the benefit of this invention is that the AODS filter is an active component. The AODS filter included in the pulse shaper 115 can compensate the TOD coming from the SMF stretcher 110 and can be used to compensate any order of dispersion generated in the amplifier chain 115, including nonlinear phase shift. Additionally the pulse shaper that includes the AODS filter can implement a programmable component to actively shape the output pulse to realize the shortest pulse duration.

As one application example, the fiber pigtailed AODS can be used for the compensation of high order phase components accumulated in the fiber stretcher and grating compressor combination. Especially in the high peak power fiber laser amplification, implying large compression ratios of more than 1000, the problem of exact compensation becomes crucial. The AODS is well adapted for generation of fourth order or higher order corrections. This feature becomes particularly important because of the issue of pulse quality (peak to background contrast) in plasma generation experiments. In a recent simulation, in the GW level peak power Yb-doped fiber laser system, by implementing a system configuration as disclosed in this invention, it is feasible to achieve as short as 200 fs duration with a pulse contrast as high as 10⁶, at least an order of magnitude higher than the conventional short pulse fiber laser amplifier system. The phase undulations can be kept below 0.15 radians in the whole spectral range.

Another application utilizes the intensity modulation the AODS provides, shown in the hole drilling feature in FIG. 2 to generate a sharp pulse intensity dip at particular frequency. The goal is to correct the gain narrowing effects in the high gain amplifier. This can be realized by modifying the intensity spectrum, in such a way that the intensity is minimal at the point of maximum gain. As an example, for an amplifier with 40 dB gain, the compensation can be achieved over the full half width (3 db) of the gain curve, if the dynamic range of intensity control reaches 30 db. In a simulation analysis of the laser system, the bandwidth was doubled, which supports twice as shorter pulse duration.

Furthermore, the fast reprogram time allows the use of the sophisticated optimization algorithms. As an example, it is possible to tune the parameters of the AODS actively to match the measured FROG pattern of the fiber amplifier. In other words, a genetic algorithm can be applied to converge to an optimal solution for the pulse duration compression. Since the phase introduced by the AODS is known with a high accuracy from the physical constants of the material, the algorithm does not depend on the geometrical parameters of the set-up and therefore, it does not require a setup calibration. If one disposes of a good phase measurement, it is then possible to program the opposite correction and obtain directly the desired flat phase, which infers the bandwidth-limited pulse width. In the optimization algorithm, the central idea is to tune the phase and intensity parameters in Equation (1). These parameters are correlated with the intensity and phase, including the “chirp”, the time dependent frequency, of the acoustic wave, as shown in FIG. 3. As shown in FIG. 2, the AODS can generate any controlled spectral shape and phase structure with a great range of flexibility.

With the capability this pulse shaper provides, the pulse stretching function performed by the SMF stretcher 110 has additional flexibility with being constrained by the difficulties caused by the issues of compressibility. As an example, for the Yb: fiber laser running at 1030 nm, with a bandwidth of 8 nm, the bandwidth-limited pulse width is around 200 fs; with 400 m fiber stretcher generated huge positive TOD, the pulse width can be as long as 700 fs. The AODS filter can compensate the TOD from the fiber component, thus it is possible to realize a pulse width about 200 fs. On the other hand, the AODS filter can overcome the gain-narrowing effect, the effective bandwidth can be increased to 12 nm, with the totally eliminated TOD, and the pulse duration can go down to 120 fs. With the second AODS filter, it is possible to have even larger stretching ratio, having greater pulse width amplification, e.g., greater than nanosecond (>ns) pulse amplification. Such laser system provides the possibility of producing mJ level sub-200 fs pulses in fiber laser.

The implementation of the fiber based AODS can be classified into many different configurations. Normally the AODS is operated in the low intensity region. Referring to FIG. 1 again, the AODS implemented as the pulse shaper 115 is combined with the fiber stretcher 110 and the grating compressor 125. In this configuration, the AODS is used to compensate the TOD in the fiber stretcher 110 and the grating compressor 125. It is necessary to use the AODS in the low intensity region for the single mode fiber pigtail. Since many acoustic materials can handle quite high power, it is very attractive to use the AODS in the medium or high power level. An interesting application would be the all fiber based high-energy amplifier. The pigtailed fiber does not have to be single mode fiber, it can be Large-Mode-Area (LMA) fiber, or it can be the Photonic Band-Gap (PBG) fiber. The fiber end can be spliced with a piece of coreless fiber to expand the beam, thus largely increase the power handling capability of the fiber pigtailed AODS.

An example application is the phase correction of pulses generated by the conventional fiber amplifier and the PBF for pulse compression. The AODS is put right after the amplifier and right before the PBF compressor; it is for the higher order dispersion corrections. A spectral width as wide as 100 nm can be controlled and the optimal pulse duration of sub 30 fs is possible. FIG. 4 shows the implementation of this type of AODS into the CPA fiber amplifier. By using the special design and package shown in FIG. 5, this setup is a real all fiber based CPA short pulse amplifier. In FIG. 5, the input fiber is the passive LMA fiber matched with the output fiber of the amplifier; the output fiber is PBG fiber for the pulse compression.

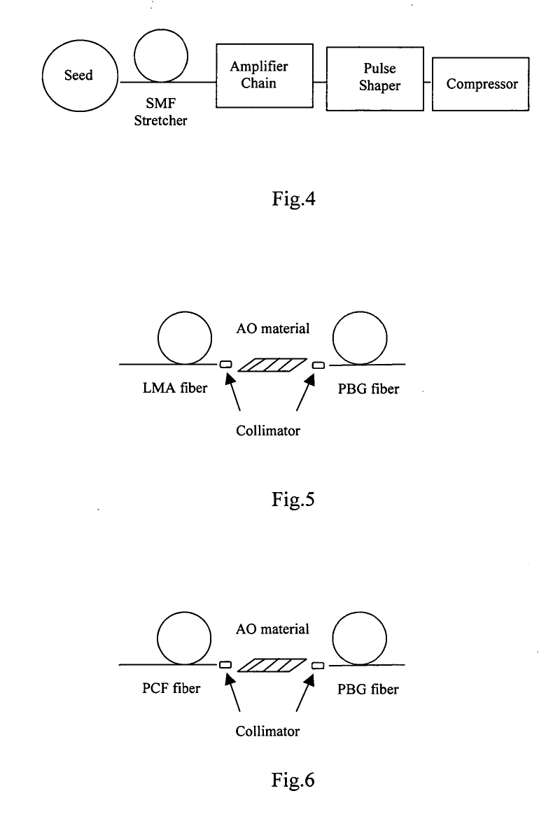

A direct extension of this idea is the spectral broadening and compression. The amplified and compressed laser pulses can be sent to a piece of photonic crystal fiber (PCF), where the self phase modulation will broaden the spectrum. The spectrally broadened pulse propagates in the AODS; the additional dispersion is then compensated. The critical component is a properly designed AODS, with wide acoustic bandwidth, can handle very broad bandwidth (200 nm). In FIG. 6, the input fiber is the small piece of PCF fiber for the spectral broadening, it can easily broaden the spectrum to 200 nm bandwidth; the output fiber can be a PBG fiber for the power delivery, or it can be free space output. The simulation shows that as short as 7 fs pulse duration is possible for a 200 nm controlled spectral width. Thus, an all fiber laser source can deliver high-energy pulses with sub 10 fs pulse duration.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A fiber Chirped Pulse Amplification (CPA) laser system comprising:
a fiber mode-locking oscillator for generating a laser to project to a pulse stretcher for stretching a pulse width of said laser; and
a pulse shaper to generated an amplitude and spectral modulated laser for projecting to a multistage amplifier chain for generating an amplified laser to project to a compressor for compressing said amplified laser wherein said pulse shape generating said amplitude and spectral modulated pulse for compensating a dispersion generated by said pulse stretcher and said multistage amplifier chain.

2. The fiber CPA laser system of claim 1 wherein:
said pulse shaper further comprising an acoustic-optical dispersive shaper (AODS).

3. The fiber CPA laser system of claim 2 wherein:
said AODS further comprising a controllable AODS for generating an adjustable amplitude and spectral modulation.

4. The fiber CPA laser system of claim 2 wherein:
said AODS further comprising a controllable AODS for generating an adjustable amplitude and spectral modulation for compensating different orders and amplitudes of said dispersion including a large third-order dispersion (TOD) generated by said pulse stretcher and said multistage amplifier.

5. The fiber CPA laser system of claim 2 wherein:
said AODS further comprising a controllable AODS includes an active and programmable dispersive component to interactively generate adjustable levels of dispersions in response to measurements of an output laser amplitude and pulse shape for flexibly compensating different order of dispersions.

6. The fiber CPA laser system of claim 2 wherein:
said AODS further comprising an acoustic-optical dispersive component for generating a modulation factor S(ω) for multiplying to an input spectrum of said laser according to equations of:
$$S ( ω ) = A ( ω ) {ⅇ}^{ⅈϕ ( ω )}$$
$$A ( ω ) = {ⅇ}^{- {( \frac{ω - {ω}_{0}}{Δ ω} )}^{6}} \times [ 1 - k \cdot {ⅇ}^{- {( \frac{ω - {ω}_{1}}{ Δ {ω}_{1}} )}^{2}} ]$$
$$ϕ ( ω ) = - [ {a}_{1} ( ω - {ω}_{0} ) + \frac{{a}_{2}}{2} {( ω - {ω}_{0} )}^{2} + \frac{{a}_{3}}{6} {( ω - {ω}_{0} )}^{3} + \frac{{a}_{4}}{24} {( ω - {ω}_{0} )}^{4} ]$$

7. The fiber CPA laser system of claim 2 wherein:
said AODS further comprising an acoustic-optical dispersive component for generating a modulation for compensating dispersions of the second, third and fourth orders.

8. The fiber CPA laser system of claim 2 wherein:
said AODS further comprising an acoustic-optical birefringent material based on a collinear acoustic-optic interaction.

9. The fiber CPA laser system of claim 2 wherein:
said AODS further comprising an acoustic-optical birefringent material composed of a tellurium dioxide crystal.

10. The fiber CPA laser system of claim 2 wherein:
said AODS further comprising an acoustic-optical birefringent material composed of gallium phosphide.

11. The fiber CPA laser system of claim 2 wherein:
said AODS further comprising an acoustic-optical birefringent material composed of indium phosphide.

12. The fiber CPA laser system of claim 2 wherein:
said AODS further comprising an acoustic-optical birefringent material composed of lithium niobate.

13. The fiber CPA laser system of claim 2 wherein:
said AODS further comprising an acoustic-optical birefringent material composed of a fused quartz.

14. The fiber CPA laser system of claim 2 wherein:
said AODS further comprising an acoustic-optical birefringent material and a transducer for exciting said acoustic-optical birefringent material by a RF signal.

15. The fiber CPA laser system of claim 2 wherein:
said AODS further comprising an acoustic-optical birefringent material and a transducer for exciting said acoustic-optical birefringent material by a RF signal to generate a refractive index wave.

16. The fiber CPA laser system of claim 2 wherein:
said AODS further comprising an acoustic-optical birefringent material and a transducer for inputting an acoustic wave along with an optical wave of said laser wherein said acoustic wave having a time delay dependent frequency for providing a control over a group delay of a diffracted optical pulse.

17. The fiber CPA laser system of claim 16 wherein:
said AODS further comprising an acoustic modulator for adjusting said acoustic wave for modulating a spectral and amplitude of said diffracted optical pulse.

18. A method for compensating a dispersion generated in a fiber Chirped Pulse Amplification (CPA) laser system comprising:
applying a pulse shaper for generating an amplitude and spectral modulated laser for compensating said dispersion generated by a pulse stretcher and a multistage amplifier chain of said CPA laser system.

19. The method of claim 18 wherein:
said step of applying said pulse shaper further comprising a step of implementing said pulse shaper as an acoustic-optical dispersive shaper (AODS).

20. The method of claim 19 wherein:
said step of implementing said AODS further comprising a step of implementing a controllable AODS for generating an adjustable amplitude and spectral modulation.

21. The method of claim 19 wherein:
said step of implementing said AODS further comprising a step of implementing said AODS as a controllable AODS for generating an adjustable amplitude and spectral modulation for compensating different orders and amplitudes of said dispersion including a large third-order dispersion (TOD) generated by said pulse stretcher and said multistage amplifier.

22. The method of claim 19 wherein:
said step of implementing said AODS further comprising a step of implementing said AODS as a controllable AODS includes an active and programmable dispersive component to interactively generate adjustable levels of dispersions in response to measurements of an output laser amplitude and pulse shape for flexibly compensating different order of dispersions.

23. The method of claim 19 wherein:
said step of implementing said AODS further comprising a step of implementing said AODS as an acoustic-optical dispersive component for generating a modulation factor S(ω) for multiplying to an input spectrum of said laser according to equations of:
$$S ( ω ) = A ( ω ) {ⅇ}^{ⅈϕ ( ω )}$$
$$A ( ω ) = {ⅇ}^{- {( \frac{ω - {ω}_{0}}{Δ ω} )}^{6}} \times [ 1 - k \cdot {ⅇ}^{- {( \frac{ω - {ω}_{1}}{ Δ {ω}_{1}} )}^{2}} ]$$
$$ϕ ( ω ) = - [ {a}_{1} ( ω - {ω}_{0} ) + \frac{{a}_{2}}{2} {( ω - {ω}_{0} )}^{2} + \frac{{a}_{3}}{6} {( ω - {ω}_{0} )}^{3} + \frac{{a}_{4}}{24} {( ω - {ω}_{0} )}^{4} ]$$

24. The method of claim 19 wherein:
said step of implementing said AODS further comprising a step of implementing said AODS as an acoustic-optical dispersive component for generating a modulation for compensating dispersions of the second, third and fourth orders.
